(19) United States
(12) Patent Application Publication
(10) Pub. No.: US 2007/0186463 A1
(43) Pub. Date: Aug. 16, 2007

(54) Blended mulch products for spray application to a surface

(76) Inventor: Doris Ericka Lougheed, Richmond (CA)

Correspondence Address: CHRISTIE, PARKER & HALE, LLP, PO BOX 7068, PASADENA, CA, 91109-7068, US

(21) Appl. No.: 11/355,509

(22) Filed: Feb. 15, 2006

(30) Foreign Application Priority Data
Feb. 14, 2006 (CA) 2536538

(51) Int. Cl. C09K 17/52

(52) U.S. Cl. 47/9

(57) ABSTRACT

The invention provides in part a blended mulch product of at least two types of bio-degradable materials having different geometric shapes and physical properties. The first type of bio-degradable material may be a ligno-cellulosic fiber, such as a refined softwood ligno-cellulosic fiber, and the second type of bio-degradable material may be a wood-based flake, such as a processed wood residual.

### FIELD OF THE INVENTION

The invention relates generally to the field of blended mulch products. More specifically, the invention provides blended mulch products to be used for covering surfaces to prevent erosion or to create a microenvironment for seed germination.

### BACKGROUND OF THE INVENTION

Mulches are used in the remediation of soil erosion. In addition, mulches aid in the establishment and growth of vegetation. Mulch products include those in which the mulch materials are applied mechanically or in an air stream, such as in straw blowing, as well as those in which the mulch materials are applied in a slurry of water, such as in hydromulching.

The materials used for hydromulching applications need particular physical characteristics to allow the material to be suspended in a water slurry, pumped through a high pressure pump and hose, and sprayed through a nozzle. For example, the mulch material should be easily loaded into a hydromulching machine, have good water holding capacity, and should not float or create clumps that could plug the nozzle. Furthermore, a higher loading capacity (the amount of mulch material that can be added to a given amount of water) mulch is advantageous, particularly if large surface areas need to be covered, since the number of batches to cover the area is reduced due to increased weight per unit volume. This results in increased productivity and less labor for the same surface area, thus decreasing the cost. Finally, the mulch material should be capable of good surface coverage after application.

Materials used for hydromulching include finely divided chopped straw or cornhusks, shredded recycled newsprint or paper, and refined wood fiber.

For example, U.S. Pat. No. 2,699,629 (Wandel) discloses the use of paper mixed with organic matter to aid in the degradation process and add nutrients to the soil; U.S. Pat. No. 4,297,810 (Hansford) discloses a sprayable mulch including hay (85%), paper (12%) and binding and coloring agents (3.0%); U.S. Pat. No. 4,067,140 (Thomas) discloses a paper mulch and the process of making the same; U.S. Pat. No. 6,523,299 (Morris) describes a mulch that includes paper and corn particles; and U.S. Pat. No. 5,916,027 (Spittle) and U.S. Pat. No. 6,158,167 (Spittle) incorporate finely divided paper and or finely divided wood with a surfactant.

U.S. Pat. No. 5,301,460 (Corbitt) discloses a mulch product manufactured using a swinging hammer type of wood hog using a surrounding screen having a plurality of holes of not less than approximately 2 inches across, where the resulting mulch product includes a shredded fine portion, a bulky portion, and a stringy binding portion. U.S. Pat. No. 6,729,068 (Dooley et al.) discloses a blended mulch product of wood elements having defined geometric shapes containing a mixture of at least two components that differ by at least one dimension, the elements having a length within the range of about 50-300 mm, a maximum width of about 30 mm, and a maximum thickness of about 7.5 mm.

Many conventional mulches can be pumped for hydromulching purposes, however, the loading capacity is dependant on the type of material used to manufacture the mulch. Conventional refined wood fiber mulch, which has string like fibers with good water absorption, has load capacity rates of approximately 1250-1300 pounds per 3000 gallons water. At loading rates greater than 1300 pounds fiber per 3000 gallons of water, however, conventional refined wood fiber mulches become very “dry” causing the high pressure pump of a hydromulching machine to struggle in its operation, which hinders the functioning of the pump and creates a high potential for clogging the hoses and nozzle of the hydromulching machine. A shredded paper-based mulch has load capacity rates of approximately 1750 pounds per 3000 gallons water. However, the ground coverage of such paper-based mulches is poor when compared to the refined wood mulches, requiring an increase of 30% in weight of the paper-based mulch to cover the same area. Furthermore, paper-based mulches, when applied to a surface, stick together in a papier-mache manner creating a crust-like material. Paper-based mulches are often recycled and may have residual inks that introduce contaminants or toxins.

### SUMMARY OF THE INVENTION

The invention provides in part a blended mulch product of two types of bio-degradable materials having different geometric shapes and physical properties. The blended mulch product can be mixed with water at a high loading rate to form a slurry that can be pumped through a hose and sprayed onto a surface to form a three-dimensional mulch matrix that provides good coverage of the surface.

In one aspect of the invention, there is provided a blended mulch product Is which can be mixed with water and spray-applied to a ground surface to form a mulch matrix. The blended mulch product comprises ligno-cellulosic fibers and wood-based flakes that are mixed to form a substantially homogeneous blend with a high loading capacity.

In another aspect of the invention, there is provided a blended mulch product which can be mixed with water and spray-applied to a ground surface to form a mulch matrix. The blended mulch product comprises EcoFibre™ and dry, hogged sawtrim from the hardboard process, that have been screened using a 0.5 inch wire mesh, that are mixed to form a substantially homogeneous blend with a high loading capacity.

In another aspect of the invention, there is provided a method of preparing a blended mulch product which can be mixed with water and spray-applied to a ground surface to form a mulch matrix, by mixing ligno-cellulosic fibers with wood-based flakes to make a substantially homogeneous blend with a high loading capacity. The ligno-cellulosic fibers and the wood-based flakes may be mechanically blended.

In various embodiments of the aspects of the invention, the ligno-cellulosic fibers may comprise about 20% to about 80% by weight of the blended mulch product, or about 35% to about 65% by weight of the blended mulch product, or about 45% to about 55% by weight of the blended mulch product, or about 50% by weight of the blended mulch product.

In various embodiments of the aspects of the invention, the ligno-cellulosic fibers may comprise a moisture content of about 9% to about 15%.

In various embodiments of the aspects of the invention, the ligno-cellulosic fibers may comprise a bulk density of about 0.11 grams per cubic centimeter to about 0.15 grams per cubic centimeter.

In various embodiments of the aspects of the invention, the ligno-cellulosic fibers may comprise refined fibers, thermomechanically refined wood fibers, softwood fibers, northern softwood SPF refined fibers, or EcoFibre™.

In various embodiments of the aspects of the invention, the ligno-cellulosic fibers may comprise a colored dye or a surfactant. The surfactant may be present at a concentration of about 0.02% to about 0.6%, e.g., about 0.2%. The surfactant may be a non-ionic surfactant, a non-toxic surfactant, a polyoxypropylene-polyoxyethylene block copolymer surfactant, or Pluronic® 25R2.

In various embodiments of the aspects of the invention, the ligno-cellulosic fibers may each individually comprise a diameter of about 0.01 mm to about 0.3 mm.

In various embodiments of the aspects of the invention, the ligno-cellulosic fibers may each individually comprise a length of about 0.06″ to about 1.5″.

In various embodiments of the aspects of the invention, about 65% to about 95% of the ligno-cellulosic fibers may comprise a fiber having a length of about 0.125″ to about 1″, or about 25% of the ligno-cellulosic fibers may comprise a fiber having an average length of about 0.4″, or at least about 47% of the ligno-cellulosic fibers may be capable of being retained on a 28 mesh screen, or about 47% to about 53% of the ligno-cellulosic fibers may be capable of being retained on a 28 mesh screen.

In various embodiments of the aspects of the invention, no greater than 15% of the ligno-cellulosic fibers may be very fine fibers.

In various embodiments of the aspects of the invention, the ligno-cellulosic fibers may each individually comprise a length that is at least about 50 times its diameter, or may each individually comprise a length that is about 50 times to about 300 times its diameter.

In various embodiments of the aspects of the invention, the ligno-cellulosic fibers may each individually comprise a string-like shape.

In various embodiments of the aspects of the invention, the ligno-cellulosic fibers may comprise a water holding capacity of at least about 12 times the weight of the ligno-cellulosic fibers.

In various embodiments of the aspects of the invention, the wood-based flakes may comprise between about 20% by weight to about 80% by weight of the blended mulch product, or about 35% by weight to about 65% by weight of the blended mulch product, or about 45% by weight to about 55% by weight of the blended mulch product, or about 50% by weight of the blended mulch product.

In various embodiments of the aspects of the invention, the wood-based flakes may comprise a processed wood residual, such as a sawmilling byproduct, a planing process byproduct, or a manufactured wood composite residual. The sawmilling byproduct may comprise sawdust, planer shavings, post peeler shavings, lathe curls, pin chips, chip fines, or chippable residue. The manufactured wood composite residual may comprise a low density fiberboard, a medium density fiberboard, a high density fiberboard, a hardboard, a particleboard, or an oriented strandboard. The processed wood residual may comprise a hogged wood residual, a hogged sawtrim wood residual, a screened and hogged wood residual, or a dried, screened and hogged wood residual.

In various embodiments of the aspects of the invention, the wood-based flakes may comprise a moisture content of 3% to about 15%.

In various embodiments of the aspects of the invention, the wood-based flakes may comprise a bulk density of about 0.16 grams per cubic centimeter to about 0.30 grams per cubic centimeter, or may comprise a bulk density that is greater than that of the ligno-cellulosic fibers.

In various embodiments of the aspects of the invention, the wood-based flakes may comprise a water holding capacity of about 2 to 9 times weight, or of about 5 to 8 times weight, or about 7.6 times weight.

In various embodiments of the aspects of the invention, the wood-based flakes may comprise a dry hogged sawtrim that has been screened using a 0.5 inch wire mesh.

In various embodiments of the aspects of the invention, the wood-based flakes may each individually comprise a dimension-to-thickness ratio of about 5 to about 100, or about 20 to about 70, or about 25 to about 40, or about 25 to about 35. About 40% to about 90%, or about 60% to about 70%, of the wood-based flakes each individually may comprise the indicated dimension-to-thickness ratio.

In various embodiments of the aspects of the invention, the wood-based flakes may each individually comprise a dimension of about 0.125″ to about 1″, or about 0.5″.

In various embodiments of the aspects of the invention, the wood-based flakes may each individually comprise a thickness of 0.004″ to about 0.03″, or about 0.01″ to about 0.025″, or about 0.01″.

In various embodiments of the aspects of the invention, the wood-based flakes may each individually comprise a length of about 0.31″, a width of about 0.21″, and a thickness of about 0.01″.

In various embodiments of the aspects of the invention, the wood-based flakes may be capable of being screened through a 0.5″ wire mesh.

In various embodiments of the aspects of the invention, the wood-based flakes may each individually comprise a two-dimensional surface area of at least about 2.5 square mm, or a two-dimensional surface area of no greater than about 322 square mm, or a two-dimensional surface area of about 2.5 square mm to about 322 square mm. About 40% to about 90%, or about 60% to about 70%, of the wood-based flakes may each individually comprise the indicated two-dimensional surface area.

In various embodiments of the aspects of the invention, the wood-based flakes may each individually comprise a dimension in the range of about 0.125″ to about 0.725″ and a thickness of at least about 0.004″.

In various embodiments of the aspects of the invention, the blended mulch product may comprise a loading capacity of greater than about 1250 to about 1300 pounds per 3000 gallons of water, or at least about 1600 pounds per 3000 gallons of water, or about 1750 pounds per 3000 gallons of water, or greater than about 1750 pounds per 3000 gallons of water.

In various embodiments of the aspects of the invention, the blended mulch product may be capable of forming a mulch matrix having good coverage.

In various embodiments of the aspects of the invention, there is provided a method of using the blended mulch product of claim 1 comprising mixing the blended mulch product with water to form a slurry and spraying the slurry on to a surface to be treated. The surface may be soil that is at risk for erosion or is eroded. The spraying may form a mulch matrix having good coverage.

### BRIEF DESCRIPTION OF THE DRAWINGS

In the accompanying drawings which illustrate embodiments of the invention,

FIG. 1 is a schematic diagram of ligno-cellulosic fibers combined with wood-based flakes, according to a first embodiment of the invention.

### DETAILED DESCRIPTION OF THE INVENTION

Reference will now be made in detail to implementations and embodiments of the invention, examples of which are illustrated in the accompanying drawings.

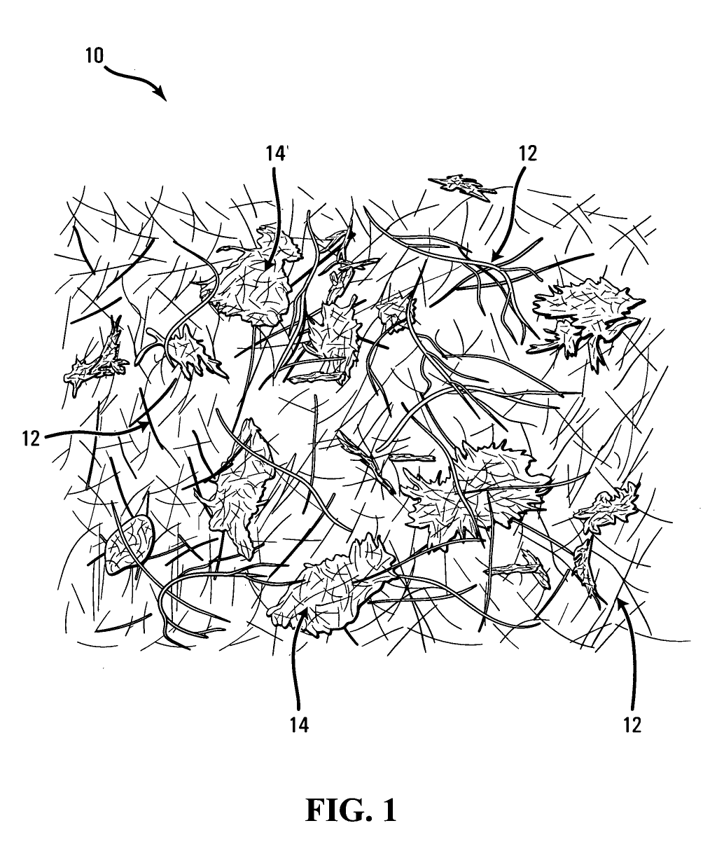

Referring to FIG. 1, there is shown a first embodiment of a blended mulch product 10 according to one aspect of the present invention. The blended mulch product 10 comprises ligno-cellulosic fibers 12 and wood-based flakes 14. In certain variations, the ligno-cellulosic fibers 12 are treated with one or more additives, such as a dye or a surfactant, as discussed below.

The ligno-cellulosic fibers 12 comprise in the range of about 20% to about 80% by weight of the blended mulch product 10. In one variation the ligno-cellulosic fibers 12 comprise about 35% to about 65% by weight of the blended mulch product 10. In another variation, the ligno-cellulosic fibers 12 comprise in the range of about 45% to about 55% by weight of the blended mulch product 10. In some embodiments, the ligno-cellulosic fibers 12 comprise about 50% by weight of the blended mulch product 10. The ligno-cellulosic fibers 12 assist in providing a mulch matrix with a large water holding capacity, to absorb water and discourage the saturation of the underlying soils.

The ligno-cellulosic fibers 12 are preferably thermomechanically refined wood fibers in the first embodiment, which have been dried to a moisture content of no more than about 9% to about 15%, and which have a bulk density, on an oven-dried basis, of about 0.11 to about 0.15 grams per cubic centimeter. Thermomechanical processes used to produce thermomechanically refined wood fibers are well known in the art. In alternative variations, other ligno-cellulosic fibers 12 may be used, and preferably they also will be thermomechanically processed to destroy fungi, nematodes and other unwanted organisms. Sources for ligno-cellulosic fibers include, without limitation, fibers derived from softwood trees (e.g., pine, fir, spruce, Douglas fir, etc.) or hardwood trees (e.g., aspen, maple, alder, etc.). Alternative sources for ligno-cellulosic fibers also include, without limitation, sawmilling residues such as sawdust, planer shavings, recycled urban waste, post peeler shavings, pulp quality chips, pin chips and chip fines; urban waste wood, such as pallets or demolition wood; etc. Preferably a softwood chip as produced from sawmilling is used, since the resultant fiber will be longer. These source materials may be processed and refined thermomechanically to produce ligno-cellulosic fibers suitable for use in the blended mulch products of the invention.

The thermomechanical process used to produce the refined wood fibers in the first embodiment separates wood chips into long strand fibers. This refining process separates individual wood fibers from each other. However lignin connecting individual fibers causes the appearance of some fiber bundles. The properties of the fiber bundles are developed by bending, crushing, pulling and pushing the fiber clumps caught between bar to bar surfaces of refiner plates used in the thermomechanical process. This is known as defiberization. The manipulation of the wood fibers in this way creates fragments branching or protruding from the main fiber stem that help in the entanglement of the mulch matrix formed herein.

A colored dye (e.g., a green dye) may be added to the refined ligno-cellulosic fibers at this point of the manufacturing process. The colored dye may visually aid a person when applying a slurry to a surface. In particular, determining the application rate and the amount of surface already covered may be aided by addition of a dye to the refined ligno-cellulosic fibers.

A surfactant may also be added to the ligno-cellulosic fibers 12 after refining. Addition of a surfactant may enhance the wetting of the ligno-cellulosic fibers and allow for proper dispersion of the ligno-cellulosic fibers when mixed with water, and reduce the tendency of the fibers to float on the surface of the water in a hydromulcher tank. The surfactant can be applied to the ligno-cellulosic fibers at a concentration of about 0.02% to about 0.6% (e.g., about 0.2%). The surfactant can be a non-ionic surfactant that can be, for example, non-toxic to plant growth at the applied concentrations. Preferably, the surfactant is a polyoxypropylene-polyoxyethylene block copolymer surfactant, e.g, Pluronic® 25R2 (BASF, Canada).

Whether or not a dye or surfactant is added as an additive to the ligno-cellulosic fibers 12, the thermomechanical process may be continued by blowing the ligno-cellulosic fibers through a flash dryer, to remove any residual liquid, followed by cycloning to separate the air from the fibers. The cycloned fibers may then be placed onto a conveyor which feeds a baler. The dried wood fibers are typically compacted into 1500 pound bales or bags of smaller sizes between 40 to 60 pounds that may be subsequently transported.

In the first embodiment, the ligno-cellulosic fibers 12 are wood fibers comprising northern softwood spruce-pine-fir (SPF) refined fibers. Such wood fiber can be obtained from various sources. In the first embodiment, the northern softwood SPF refined fibers are EcoFibre™ product (Product 17) as supplied by Canadian Forest Products Ltd., which has a suitable length and is capable of intertwining with other similar fibers, providing added integrity to the mulch matrix once formed on the ground surface.

In general, the ligno-cellulosic fibers 12 used in the blended mulch product 12 each individually may have a diameter from about 0.01 mm to about 0.3 mm and a length along an elongated portion from about 0.06 inches to about 1.5 inches (about 1.5 mm to about 38 mm). The process used to manufacture the ligno-cellulosic fibers 12 determines the length of the ligno-cellulosic fibers 12.

In a thermomechanical process, the refiner plate configuration, processing conditions and the species of wood chips fed to the refiner all contribute to the final length of the fibers produced.

In the first embodiment, the ligno-cellulosic fibers 12 are manufactured to have a minimum of about 25% averaging about 0.4 inches (about 10 mm) in length, and about 47% to 53% of the fiber retained on a 28 mesh screen—as measured using the Ro-Tap fiber classification method (5 grams screened for 5 minutes). Preferably, about 65% to about 95% of the ligno-cellulosic fibers 12 in the blended mulch product 10 have a length in the 0.125 inches to 1 inch (about 3.2 mm to about 25.4 mm) range. This latter range is preferred since ligno-cellulosic fibers 12 having a length in this range further promote the natural entanglement of the fibers in the mulch matrix (once formed) while not impeding the proper mixing of the blended mulch product 10 with water in a hydromulcher tank to form a slurry, and while also allowing the slurry to flow uninhibited through a hydromulching hose and nozzle so as to be spray-applied to a surface. In the first embodiment, the ligno-cellulosic fibers 12 may have a size range as described herein in Example 1 below. A large percentage (no greater than 15%) of very fine fibers, such as fibers under 1.5 mm in length or under about 0.1 mm in diameter, are not desired since they may be associated with annoying levels of dust in the mulch matrix and may float when added to water to form the slurry.

In general, the ligno-cellulosic fibers 12 have a length that is at least about 50 times its diameter, for example, a length that is about 50-300 times its diameter. In general, an individual ligno-cellulosic fiber 12 may have a string-like shape i.e., be in a long, thin, and flexible configuration, although some ligno-cellulosic fibers for use in the invention may be held together in clumps or bundles by lignin, or have branch-like fibers extending from the main stem. Those of skill in the art would recognize these. A suitable ligno-cellulosic fiber 12 is a fiber which is capable of providing the required entanglement of a mulch matrix, but which does not impede the mixing of a blended mulch product 10 according to the invention in a hydromulching tank to form a substantially homogeneous slurry, and which allows the slurry to flow uninhibited through a hydromulching hose and nozzle.

Preferably, the ligno-cellulosic fibers 12 used in the blended mulch product 10 have a high water holding capability. Typically such fibers can hold over twelve times their own weight in water. By “water holding capacity” is meant the amount of water that the fiber can hold as compared to the original dry weight of the fiber. This property helps the mulch matrix absorb water from precipitation thus reducing the amount of rain penetrating to the underlying soils, which in turn helps prevent rilling of the soil. Furthermore, a high water holding capability increases the moisture holding ability of the mulch matrix, which in turn provides an environment that promotes seed germination and plant growth.

Over a period of weeks, plant roots may penetrate the underlying soil and this will help to hold the soil surfaces together, thereby inhibiting soil erosion. The moist environment provided by the resulting mulch matrix described herein together with an adequate supply of oxygen and warm temperatures often promotes eventual biodegradation of the mulch matrices themselves and the decay of the ligno-cellulosic fibers 12 which in turn provides a nutrient source for plants. The ligno-cellulose fibers 12 can also provide a frame or mesh for the wood-based flakes 14.

Referring to FIG. 1, the wood-based flakes 14 form a second component of the blended mulch product 10. In general, the wood-based flakes 14 comprise in the range of about 20% to about 80% by weight of the blended mulch product 10. In one variation, the wood-based flakes 14 comprise about 35% to about 65% by weight of the blended mulch product 10. In another variation, the wood-based flakes 14 comprise in the range of about 45% to about 55% by weight of the blended mulch product 10. In some embodiments, the wood-based flakes 14 comprise about 50% by weight of the blended mulch product 10. The wood-based flakes 14, when combined with the lignocellulose fibers 12, provide a blended mulch product that can be mixed with water to form a slurry that can be pumped through the hose and nozzle of a hydromulching apparatus at a high weight per volume ratio.

The wood-based flakes 14 comprise at least one type of wood-based residual material that has been processed to provide for suitable defined physical characteristics suitable for as described below. Sources for wood-based residual material suitable to produce the wood-based flakes 12 include, without limitation, recycled or recyclable wood materials, including a by-product of sawmilling, a by-product of the planing process, or a manufactured wood composite residual. Wood-based residuals or wood residuals are chunks of wood fragments, pieces or particles that are generated in all stages of forest use, from the harvesting of trees to the final manufacturing processes. These products include panel products, furniture, and miscellaneous wood products, which in turn create their own residues. Wood residuals include sawmilling residues such as sawdust, planer shavings, post peeler shavings, lathe curls, pin chips, chip fines and chippable residue, hogged sawtrim residuals from the hardboard process or screened shavings, sander dust, veneer and plywood trims, engineered wood composite trims, hardboard, particleboard, medium or high density fibreboard, oriented strandboard, urban waste wood, such as pallets or demolition wood, etc., and any combinations thereof. In general, wood-based residuals are not subjected to processes designed to remove lignin and therefore contain lignin. These source materials may be processed by for example drying, hogging, and sizing, to produce wood-based flakes suitable for use in the blended mulch products of the invention.

Preferably, the blended mulch product 10 specifically exclude any quantity or any significant quantity of material derived from paper, newsprint, corn, hay, or straw. A significant quantity would be any amount of material derived from paper, newsprint, corn, hay, or straw that would result in the blended mulch product 10 forming a crust-like material, instead of a three-dimensional open-weave matrix, when applied to a surface. A significant quantity would also be any amount of material derived from paper, newsprint, corn, hay, or straw that would result in the blended mulch product 10 providing poor coverage, i.e., coverage similar to that provided by a conventional wood/paper blended mulch product, when applied to a surface. A significant quantity would also be any amount of material derived from paper, newsprint, corn, hay, or straw that would result in the blended mulch product 10 having a poor water holding capacity when applied to a surface, causing undesired drying of the resultant mulch matrix. Preferably, material derived from paper, newsprint, corn, hay, or straw would not exceed about 10% by weight of the blended mulch product 10, more preferably, about 5% by weight of the blended mulch product 10, and more preferably yet, about 0% by weight of the blended mulch product 10.

In the first embodiment, the wood-based residual material used to form the wood-based flakes 14 are preferably hogged, manufactured wood composites, which have been dried to a moisture content of no more than about 3% to about 15%, and which have a bulk density, on an oven-dried basis, of about 0.16 grams to about 0.30 grams per cubic centimeter, and a water holding capacity of about 2 times to 9 times their weight in water, more preferably about 5 times to about 8 times their weight in water. In one embodiment, the wood-based flakes 14 have a water holding capacity of 7.6 times their weight in water. In general, wood-based flakes have a bulk density that is greater than that of ligno-cellulosic fibers. In general, wood-based flakes have pliability that is lesser than that of ligno-cellulosic fibers. In general, a wood-based flake has a shape that enables it to be relatively pliable and less prone for nozzle blockage, while maintaining its shape in the dry blended mulch product, and substantially maintaining its shape when wet in the slurry and mulch matrix. In general, hogging generates wood-based flakes having a varied distribution of sizes. Hogging processes are well known in the art. In alternative variations, other wood-based residuals may be used, such as those discussed earlier, and preferably they also will be processed to destroy fungi, nematodes and other unwanted organisms.

As mentioned above, in the first embodiment, the wood-based flakes 14 are made by processing source wood-based residual materials, including using a hogging head, to produce defined physical characteristics suitable for hydromulching purposes. Once the wood-based residual material is hogged, the resulting hogged material is then screened to obtain suitably sized wood-based flakes 14 for use in the blended mulch product 10. In addition, if the source wood-based residual material is not suitably dry, it may be dried to a moisture content of no more than about 3% to about 15% prior to hogging. The source wood-based residual material is also preferably processed to remove fungi, nematodes, and other unwanted organisms.

In the first embodiment, the wood-based flakes 14 are dry, hogged sawtrim from the hardboard process that have been screened using a 0.5 inch wire mesh.

In general, a substantial portion of the wood-based flakes 14 used in the blended mulch product 10 preferably each individually have a dimension (e.g., length or width) in the range of about 5 times to about 100 times its thickness. In one variation, a substantial portion of the wood-based flakes 14 each individually have a dimension (e.g., length or width) in the range of about 20 times to about 70 times its thickness. In another variation, a substantial portion of the wood-based flakes 14 each individually have a dimension (e.g., IS length or width) in the range of about 25 times to about 40 times its thickness. In another variation, a substantial portion of the wood-based flakes 14 each individually have a dimension (e.g., length or width) in the range of about 25 times to about 35 times its thickness. The ratio of the dimension (e.g. length or width) of a wood-based flake to its thickness is referred to herein as the “dimension-to-thickness ratio”. In some embodiments, at least about 40% by weight of the wood-based flakes 14 have at least one of the above-referenced dimension-to-thickness ratios. In other embodiments, at least about 50% by weight of the wood-based flakes 14 have at least one of the above-referenced dimension-to-thickness ratios. In other embodiments, at least about 60% by weight of the wood-based flakes 14 have at least one of the above-referenced dimension-to-thickness ratios. In other embodiments, about 40% to 90%, and in some embodiments preferably about 60% to 70%, of the wood-based flakes 14 have at least one of the above-referenced dimension-to-thickness ratios.

The wood-based flakes 14 used in the blended mulch product 10 each individually may have a dimension (length or width) in the range of about 0.125″ to about 1″ (about 3.2 mm to about 25.4 mm), and a thickness in the range of about 0.004″ to about 0.03″ (about 0.1 mm to about 0.8 mm). Preferably, wood-based flakes 14 have a thickness in the range of about 0.01″ to about 0.025″ (about 0.25 mm to about 0.64 mm). More preferably, the wood-based flakes 14 are about 0.01“(about 0.25 mm) in thickness. In some embodiments, wood-based flakes 14 have an average length x width x thickness of about 0.31″×0.21″×0.01″. In some embodiments, a wood-based flake includes the range of sizes as described herein in Example 1 (Sawtrim). In some embodiments, a wood-based flake can be screened through a 0.5″ mechanical mesh screen.

In general, a substantial portion of the wood-based flakes 14 are generally thin, flake-like pieces, each preferably having a generally flat region having a two-dimensional surface area of at least about 2.5 square mm. In some embodiments, the two-dimensional surface area of the generally flat region of each of the substantial portion of the wood-based flakes 14 is no greater than about 0.5 square inch (322 square mm). In other embodiments, the two-dimensional surface area is at least about 0.004 square inches (2.5 square mm) to about 0.5 square inch (322 square mm). In general, when referring to a substantial portion of the wood-based flakes 14, about 40% to 90%, and in some embodiments preferably about 60% to 70%, of the wood-based flakes 14 have generally thin, flake-like characteristics and a generally flat region having a minimum predetermined surface area. Preferably, 40% to 75% of wood-based flakes 14 have a dimension in the range of about 0.125″ to about 0.725″ and a thickness of at least 0.004″.

A person of skill in the art will understand that although the sizes of the wood-based flakes 14 are described herein, in some embodiments, as being of defined length, width, and thickness, natural materials may be irregularly shaped and therefore no specific geometry is intended or desired, as long as a substantial portion of the wood-based flakes 14 are generally thin, flake-like pieces each having a generally flat region having a two-dimensional surface area of at least about 2.5 square mm. In some embodiments, the wood-based flakes 14 may have a generally rectangular, triangular, or polygonal shape although precision or accuracy in the shapes is not important, as long as a sufficient quantity of the wood-based flakes are generally thin, flake-like pieces each having a generally flat region having a two-dimensional surface area of at least about 2.5 square mm.

A suitable wood-based flake is a processed wood-based material that is capable of imparting improved fiber lubricity (fiber-to-fiber interaction in water) to a water-based slurry when combined with ligno-cellulosic fibers to form a blended mulch product. By “improved fiber lubricity” is meant a reduction of friction of the material interacting in the slurry solution. The interaction of the ligno-cellulose fibers and the wood-based flakes allow a higher loading capacity in the slurry compared to mulch products without wood-based flakes, since the higher bulk density of the wood-based flakes may make the blended mulch product more compact and allow for an increased weight per unit volume of slurry. The blended mulch products of the invention therefore provide an increased loading capacity, i.e., greater than about 1250-1300 pounds blended mulch product per 3000 gallons water, more preferably, at least about 1600 pounds blended mulch product per 3000 gallons water. In some embodiments, the blended mulch products of the invention provide a loading capacity of about 1600 to about 2100 pounds per 3000 gallons of water, more preferably about 1600 to about 2000 pounds per 3000 gallons of water, for example, about 1750 pounds per 3000 gallons water. In some embodiments, the blended mulch products of the invention provide a loading capacity of greater than about 1750 pounds per 3000 gallons water. Mixing the blended mulch product with water to form a slurry allows the slurry to be pumped and flow through the hose of for example a hydromulching apparatus at a higher weight per volume of water.

The higher loading capacity enables good surface coverage (i.e., the extent to which the ground surface is overlayed or protected by the mulch matrix) with the same amount of mulch material, once spray-applied on the ground. In some embodiments, the mulch matrices of the invention provide coverage of about 25% to about 40% greater than conventional wood or paper blended mulch product mulches. The thin, flake-like geometry of the wood-based flakes 14 aid in separating the ligno-cellulosic fibers 12 by dividing the fiber masses, and may allow the ligno-cellulosic fibers to lie generally flat on the surface to which the blended mulch product is applied, to provide the greater coverage. The elongated ligno-cellulosic fibers provide even coverage of the surface.

The wide distribution of shapes and sizes (see Example 3 herein) provides good spraying performance of the slurry being pumped out of the fan nozzle of a hydromulching machine.

The ligno-cellulosic fibers 12 and wood-based flakes 14, with their physical characteristics of size, bulk density and moisture content, are combined to form a generally dry blended mulch product having a high loading capacity when mixed with water to form a wet blended mulch product or slurry which can be sprayed onto a surface to create an open-weave, three-dimensional mulch matrix. In general, the blended mulch products of the invention are substantially free of growth-inhibiting chemicals.

In the first embodiment, the blended mulch product 10 described herein is typically prepared by mechanically blending the components together, although other methods of mixing known to one skilled in the art may be used. In the first embodiment, specific proportions of ligno-cellulosic fibers 12 and wood-based flakes 14 (e.g., 45-55% wood-based flakes 14) are placed on a horizontal conveyor, which then empties into a tall vertical chute. The ligno-cellulosic fibers 12 and wood-based flakes 14 are blended as they fall down the chute. The chute feeds a compacting ram which then compresses the blended ligno-cellulosic fibers 12 and wood-based flakes 14 into about 1600 lb bales or into 50 to 60 lb plastic bags. Other quantities of blended mulch product 10 and other forms of packaging can be used.

Such a packaging procedure with mechanical mixing of the components of the blended mulch product 10 helps to thoroughly mix the individual ligno-cellulosic fibers 12 and wood-based flakes 14 so that the blended mulch product is substantially homogeneous. The dry blending of the components (the ligno-cellulosic fibers 12 and the wood-based flakes 14) can affect the performance characteristics of the slurry and mulch matrix once the blended mulch product is mixed with water and applied to a surface.

Mechanical blending provides a suitable dispersion of precise quantities of the ligno-cellulosic fibers 12 and wood-based flakes 14, such that the wood-based flakes 14 are mixed into and amongst the ligno-cellulosic fibers 12, reducing or preventing clumping of fibers (e.g. due to entanglement) and allowing a higher loading capacity in the slurry and greater coverage of the mulch when spray-applied to a surface. Clumping of fibers can cause machinery used to apply the slurry to a surface, such as a hydromulcher, to clog or break down. Clumping of fibers can also result in weak spots in the mulch matrix formed using the blended mulch product.

The blended mulch products described herein provide substantially homogeneous blends so that substantially homogeneous slurries may be formed. Substantially homogeneous slurries are pumpable through lengths of hosing for application to the desired ground surface. The components of the blends, each with their physical characteristics, act together, when mixed with water, to reduce the blockage of hosing and other spray apparatus and machinery, as well as reducing the disruption of application of the slurry, thereby forming a substantially homogenous mulch matrix on the ground surface. Blends described herein, when mixed with water, yield a smooth, lump-free slurry in which the various insoluble components are uniformly suspended. Slurries produced by blends described herein have a fiber lubricity (fiber-to-fiber interaction in water) that provides consistent application, can be sprayed over a greater ground surface area, and yet does not adversely run or flow when applied to a desired surface.

Blended mulch products described herein are formed into slurries by the addition of water. Optionally, other materials such as seeds, fertilizers, lime and other additives may also be added to the hydromulching tank or the slurry. Approximately about 50 pounds to about 60 pounds of the blended mulch product may be added per 100 U.S. gallons of water, although loading rates may vary depending on the type and working performance of the machine used.

For a mechanical agitation hydromulcher, for example, a slurry is prepared by filling the tank of the hydromulcher with about 25% of the quantity of water to be used and starting the agitation. Water and the blended mulch product is then added simultaneously, yet over a period of time to allow for thorough mixing, until the desired amount of each is reached (e.g., about 50 pounds of the blended mulch product per 100 U.S. gallons of water is prepared initially, and increased to about 60 pounds of the blended mulch product per 100 U.S. gallons, if feasible). For a recirculation type hydromulcher, for example, a slurry is prepared by filling the tank of the hydromulcher with about 75% of the quantity of water to be used and starting the agitation. The blended mulch product (which may be compacted) is added slowly, with large pieces being broken up before being dropped into the tank. Water and the blended mulch product are added at a steady rate over a period of time until the desired amount of each is reached (e.g., about 40 to 45 pounds of the blended mulch product per 100 U.S. gallons of water is prepared initially, and increased to about 55 pounds of the blended mulch product per 100 U.S. gallons, if feasible).

For both types of hydromulchers, before application to a surface, the slurry is generally mixed for about 3-5 minutes, after adding the last amount of the blend. The period of time for the mixing of the blended mulch product and the water is preferably not less than 3-5 minutes and not more than 120 minutes. For the duration of the addition of water and blended mulch product to the tank, the slurry should be agitated. Once all of the blended mulch product and water is in the tank, agitation is preferably continued for a period of not less than about 5 minutes, and preferably not less than about 10 minutes, in order to achieve a higher quality slurry. Conventional hydromulching tanks known in the art are suitable for preparing slurries described herein.

If seed is to be added, it may be added when the tank is about half full, though the addition of seed may be done at any time. Fertilizer may be generally added at the end, once the all the other components of the slurry have been added, though fertilizer may also be added at any time. Slurries described herein may be spray-applied to a surface in order to dry into a mulch matrix.

A preferred nozzle for finishing the application of slurries described herein to form mulch matrices described herein is a fan nozzle.

Slurries described herein are preferably applied so that they form a layer that is at least 0.125 inches or 3 mm thick but any layer that is between 0.08 inches and 0.20 inches in thickness will provide reasonable mulch matrices while allowing revegetation. Preferably, to minimize shadowing caused by uneven soil surfaces, at least two applications of the slurry are spray-applied to the ground surface where each application is carried out in a different direction. The second application may be applied 1-3 minutes after the first application of the slurry. Outdoor conditions, including wind and rain, can affect the application of slurries. A person applying or planning to apply slurries should exercise judgement with respect to wind direction and weather forecasts when applying slurries, in order to ensure that mulch matrices having the desired thickness and application rate. The application rate may also vary according to specific site conditions (e.g., soil conditions, steepness). The application rate will vary from 1200 pounds on a generally flat surface to about 2000 pounds of the blended mulch product applied per acre on a 3:1 (H:V) inclined slope.

The mulch matrix can provide good coverage of the surface and create an three-dimensional open-weave configuration. After application of the slurry, the mulch matrix may provide a protective shield on the surface to resist the impact of raindrops and the effect of wind velocity. The mulch matrix may also in the establishment and growth of vegetation by providing a moist environment and enhanced soil temperatures for germination. The mulch matrix may be of an open weave to allow germination and rooting of seedlings. The high water holding capacity of the mulch matrix may allow absorption of water with the concomitant reduction in saturation of the underlying soil. In general, the mulch matrices formed using the blended mulch products of the invention are biodegradable and may last about 2 to 5 months after application to a ground surface.

Various alternative embodiments and examples of the invention are described herein. These embodiments and examples are illustrative and should not be construed as limiting the scope of the invention.

### EXAMPLE 1

### Fiber Classification

The two types of materials used in the blends were classified based on the percentage retention on a screen mesh (Table 1) using the Ro-Tap fiber classification method. These fiber classification tests use Standard Wire mesh screen sizes, where the mesh sizes are inversely proportional to the size of the holes in the screen. Briefly, a 5 gram sample of each material was placed on the top screen of a stack of 8 inch diameter screens, layered such that the largest opening screen was on the top. The screen sizes were 10-, 20-, 40-, 60-, 80-, 100-, and 200-mesh, with pan to catch the undersized 200-mesh material. The screen stack was placed in a Ro-Tap testing sieve shaker and allowed to run for 25 minutes. The retained material on each screen was weighed and percentage retained of total weight was calculated. Each size fraction was described using a range and to detail the fiber size distribution (Table 1). The percent retained by each mesh size will preferably be in the approximate range set out in the range column in Table 1.

TABLE 1
Fiber Classification

| | % Retained on Mesh | | | Sample |
|---|---|---|---|---|
| Mesh | Range | Sample 1 | Sample 2 | Average |

Ecofibre Product 17 Data

| | | | | |
|---|---|---|---|---|
| +10 | 3-10 | 3.6 | 9.8 | 6.7 |
| +20 | 12-20 | 18.6 | 13.4 | 16.0 |
| +40 | 20-25 | 23.7 | 23.0 | 23.4 |
| +60 | 20-25 | 23.5 | 23.0 | 23.3 |
| +80 | 10-12 | 10.8 | 10.7 | 10.7 |
| +100 | 5-8 | 6.6 | 6.9 | 6.7 |
| +200 | 5-8 | 6.1 | 6.3 | 6.2 |
| pan | 6-7 | 7.0 | 6.9 | 6.9 |

Sawtrim Data

| | | | | |
|---|---|---|---|---|
| +10 | 40-50 | 47.3 | 47.5 | 47.4 |
| +20 | 15-20 | 19.7 | 18.9 | 19.3 |
| +40 | 10-13 | 11.2 | 10.7 | 11.0 |
| +60 | 6-8 | 7.3 | 7.6 | 7.4 |
| +80 | 2-4 | 2.9 | 3.2 | 3.0 |
| +100 | 1-3 | 2.1 | 2.0 | 2.0 |
| +200 | 4-6 | 5.2 | 5.2 | 5.2 |
| pan | 4-6 | 4.4 | 5.0 | 4.7 |

Larger Mesh size indicates smaller size of hole in screen

The data indicate that a ligno-cellulosic fiber, EcoFibre™ (Product 17), has a good distribution of fibers within each size fraction, while 66.7% of the sawtrim (a wood residual) has the majority of the size fraction distributed in the larger sizes—i.e. a +20 mesh size distribution.

### EXAMPLE 2

### Fiber Lubricity Test on Untreated Fibers

To quantify the lubricity of the fibers in solution, a 7 gram sample of fiber (based on 12% MC) was placed into 300 milliliters of tap water at ambient room temperature. The material was stirred with a spoonula and rated against two known fibers—a very finely ground refined wood fiber (VFO) (screened fiber is +28 Mesh is 35% to 45% of total weight) available from Canadian Forest Products Ltd., Product Number 3-F3-45), that was rated a 1, and a 50% blended mulch product of refined wood fiber and 50% cellulose paper known for its high loading characteristics, that was rated a 10. The fiber lubricity rating of 10 indicated that slurry was easier to stir because of less interaction of the fibers between one another. The lubricity test was conducted on the refined softwood fiber, hogged hardboard sawtrim and various blends. No surfactant was used to treat the fibers.

TABLE 2

| | Lubricity Test |
|---|---|
| Sample | Rating |
| VFO | 1 |
| 50% Wood/50% Paper | 10 |
| Sawtrim | 12 |
| Product 17 | 2 |
| 10% Sawtrim/90% Product 17 | 3 |
| 30% Sawtrim/70% Product 17 | 6.5 |
| 50% Sawtrim/50% Product 17 | 10 |

Table 2 illustrates that an addition of sawtrim fiber to the refined fiber—Product 17 increases the fiber lubricity to the same level as a known wood/paper mulch.

### EXAMPLE 3

### Fiber Lubricity Test on Treated Fibers

Various concentrations of Pluronic 25R2 surfactant was used to treat the Product 17 refined fiber. The treated fiber was blended with different levels of untreated sawtrim and the fiber lubricity test was conducted on the blended samples.

TABLE 3

| | Concentration of | Lubricity Test |
|---|---|---|
| Sample | Surfactant on Product 17 | Rating |
| VFO | — | 1 |
| 50% Wood/50% Paper | — | 10 |
| 50% Sawtrim/50% Product 17 | 0 | 10 |
| 50% Sawtrim/50% Product 17 | 0.1 | 11 |
| 50% Sawtrim/50% Product 17 | 0.2 | 12 |
| 50% Sawtrim/50% Product 17 | 0.3 | 12 |

Table 3 illustrates the results showing that with a surfactant, the lubricity of the fibers increases to a 12 from an untreated fiber lubricity rating of only 10.

As can be seen from Examples 2 and 3, at loading rates greater than 1300 lbs fiber per 3000 gallons of water, if a refined wood fiber is used alone, the fiber can tend to form a mass which creates difficulties for the high pressure pump to operate and for the material to flow out the hose and be sprayed through a nozzle. This decrease in the fiber lubricity of the slurry can be overcome by incorporating the sawtrim material (residual wood fibers) having a flake-like geometry and higher bulk density.

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Numeric ranges are inclusive of the numbers defining the range. In the specification, the word “comprising” is used as an open-ended term, substantially equivalent to the phrase “including, but not limited to”, and the word “comprises” has a corresponding meaning. Citation of references herein shall not be construed as an admission that such references are prior art to the present invention. All publications are incorporated herein by reference as if each individual publication were specifically and individually indicated to be incorporated by reference herein and as though fully set forth herein. The invention includes all embodiments and variations substantially as hereinbefore described and with reference to the examples and drawings.

What is claimed is:

1. A blended mulch product suitable for mixing with water for spray application to a surface, the blended mulch product comprising:
a) a plurality of ligno-cellulosic fibers; and
b) a plurality of wood-based flakes,
in a substantially homogeneous blend, wherein the blended mulch product has a high loading capacity.

2. The blended mulch product of claim 1 wherein the ligno-cellulosic fibers comprise about 20% to about 80% by weight of the blended mulch product.

3. The blended mulch product of claim 1 wherein the ligno-cellulosic fibers comprise about 35% to about 65% by weight of the blended mulch product.

4. The blended mulch product of claim 1 wherein the ligno-cellulosic fibers comprise about 45% to about 55% by weight of the blended mulch product.

5. The blended mulch product of claim 1 wherein the ligno-cellulosic fibers comprise about 50% by weight of the blended mulch product.

6. The blended mulch product of claim 1 wherein the ligno-cellulosic fibers comprise a moisture content of about 9% to about 15%.

7. The blended mulch product of claim 1 wherein the ligno-cellulosic fibers comprise a bulk density of about 0.11 grams per cubic centimeter to about 0.15 grams per cubic centimeter.

8. The blended mulch product of claim 1 wherein the ligno-cellulosic fibers comprise thermomechanically refined wood fibers.

9. The blended mulch product of claim 1 wherein the ligno-cellulosic fibers comprise refined fibers.

10. The blended mulch product of claim 1 wherein the ligno-cellulosic fibers comprise softwood fibers.

11. The blended mulch product of claim 1 wherein the ligno-cellulosic fibers comprise northern softwood SPF refined fiber.

12. The blended mulch product of claim 1 wherein the ligno-cellulosic fibers comprise EcoFibre™.

13. The blended mulch product of claim 1 wherein the ligno-cellulosic fibers further comprise a coloured dye.

14. The blended mulch product of claim 1 wherein the ligno-cellulosic fibers further comprise a surfactant.

15. The blended mulch product of claim 14 wherein the surfactant is present at a concentration of about 0.02% to about 0.6%.

16. The blended mulch product of claim 15 wherein the surfactant is present at a concentration of about 0.2%.

17. The blended mulch product of claim 14 wherein the surfactant is a non-ionic surfactant.

18. The blended mulch product of claim 14 wherein the surfactant is a non-toxic surfactant.

19. The blended mulch product of claim 14 wherein the surfactant is a polyoxypropylene-polyoxyethylene block copolymer surfactant.

20. The blended mulch product of claim 14 wherein the surfactant is Pluronic®25R2.

21. The blended mulch product of claim 1 wherein the ligno-cellulosic fibers each individually comprise a diameter of about 0.01 mm to about 0.3 mm.

22. The blended mulch product of claim 1 wherein the ligno-cellulosic fibers each individually comprise a length of about 0.06″ to about 1.5″.

23. The blended mulch product of claim 1 wherein about 65% to about 95% of the ligno-cellulosic fibers comprise a fiber having a length of about 0.125″ to about 1″.

24. The blended mulch product of claim 1 wherein about 25% of the ligno-cellulosic fibers comprise a fiber having an average length of about 0.4″.

25. The blended mulch product of claim 1 wherein at least about 47% of the ligno-cellulosic fibers are capable of being retained on a 28 mesh screen.

26. The blended mulch product of claim 1 wherein about 47% to about 53% of the ligno-cellulosic fibers are capable of being retained on a 28 mesh screen.

27. The blended mulch product of claim 1 wherein no greater than 15% of the ligno-cellulosic fibers are very fine fibers.

28. The blended mulch product of claim 1 wherein the ligno-cellulosic fibers each individually comprise a length that is at least about 50 times its diameter.

29. The blended mulch product of claim 1 wherein the ligno-cellulosic fibers each individually comprise a length that is about 50 times to about 300 times its diameter.

30. The blended mulch product of claim 1 wherein the ligno-cellulosic fibers each individually comprise a string-like shape.

31. The blended mulch product of claim 1 wherein the ligno-cellulosic fibers comprise a water holding capacity of at least about 12 times the weight of the ligno-cellulosic fibers.

32. The blended mulch product of claim 1 wherein the wood-based flakes comprise between about 20% by weight to about 80% by weight of the blended mulch product.

33. The blended mulch product of claim 1 wherein the wood-based flakes comprise between about 35% by weight to about 65% by weight of the blended mulch product.

34. The blended mulch product of claim 1 wherein the wood-based flakes comprise between about 45% by weight to about 55% by weight of the blended mulch product.

35. The blended mulch product of claim 1 wherein the wood-based flakes comprise about 50% by weight of the blended mulch product.

36. The blended mulch product of claim 1 wherein the wood-based flakes comprise a processed wood residual.

37. The blended mulch product of claim 36 wherein the processed wood residual comprises a sawmilling byproduct, a planing process byproduct, or a manufactured wood composite residual.

38. The blended mulch product of claim 37 wherein the sawmilling byproduct comprises sawdust, planer shavings, post peeler shavings, lathe curls, pin chips, chip fines, or chippable residue.

39. The blended mulch product of claim 37 wherein the manufactured wood composite residual comprises a low density fiberboard, a medium density fiberboard, a high density fiberboard, a hardboard, a particleboard, or an oriented strandboard.

40. The blended mulch product of claim 36 wherein the processed wood residual comprises a hogged wood residual.

41. The blended mulch product of claim 36 wherein the processed wood residual comprises a hogged sawtrim wood residual.

42. The blended mulch product of claim 36 wherein the processed wood residual comprises a screened and hogged wood residual.

43. The blended mulch product of claim 36 wherein the processed wood residual comprises a dried, screened and hogged wood residual.

44. The blended mulch product of claim 1 wherein the wood-based flakes comprise a moisture content of 3% to about 15%.

45. The blended mulch product of claim 1 wherein the wood-based flakes comprise a bulk density of about 0.16 grams per cubic centimeter to about 0.30 grams per cubic centimeter.

46. The blended mulch product of claim 1 wherein the wood-based flakes comprise a bulk density that is greater than that of the ligno-cellulosic fibers.

47. The blended mulch product of claim 1 wherein the wood-based flakes comprise a water holding capacity of about 2 to 9 times weight.

48. The blended mulch product of claim 1 wherein the wood-based flakes comprise a water holding capacity of about 5 to 8 times weight.

49. The blended mulch product of claim 1 wherein the wood-based flakes comprise a water holding capacity of about 7.6 times weight.

50. The blended mulch product of claim 1 wherein the wood-based flakes comprise a dry hogged sawtrim that has been screened using a 0.5 inch wire mesh.

51. The blended mulch product of claim 1 wherein the wood-based flakes each individually comprise a dimension-to-thickness ratio of about 5 to about 100.

52. The blended mulch product of claim 1 wherein the wood-based flakes each individually comprise a dimension-to-thickness ratio of about 20 to about 70.

53. The blended mulch product of claim 1 wherein the wood-based flakes each individually comprise a dimension-to-thickness ratio of about 25 to about 40.

54. The blended mulch product of claim 1 wherein the wood-based flakes each individually comprise a dimension-to-thickness ratio of about 25 to about 35.

55. The blended mulch product of claim 51 wherein about 40% to about 90% of the wood-based flakes each individually comprise the dimension-to-thickness ratio.

56. The blended mulch product of claim 55 wherein about 60% to about 70% of the wood-based flakes each individually comprise the dimension-to-thickness ratio.

57. The blended mulch product of claim 1 wherein the wood-based flakes each individually comprise a dimension of about 0.125″ to about 1″.

58. The blended mulch product of claim 57 wherein the wood-based flakes each individually comprise a dimension of about 0.5″.

59. The blended mulch product of claim 1 wherein the wood-based flakes each individually comprise a thickness of 0.004″ to about 0.03″.

60. The blended mulch product of claim 59 wherein the wood-based flakes each individually comprise a thickness of about 0.01″ to about 0.025″.

61. The blended mulch product of claim 60 wherein the wood-based flakes each individually comprise a thickness of about 0.01″.

62. The blended mulch product of claim 1 wherein the wood-based flakes each individually comprise a length of about 0.31″, a width of about 0.21″, and a thickness of about 0.01″.

63. The blended mulch product of claim 1 wherein the wood-based flakes are capable of being screened through a 0.5″ wire mesh.

64. The blended mulch product of claim 1 wherein the wood-based flakes each individually comprise a two-dimensional surface area of at least about 2.5 square mm.

65. The blended mulch product of claim 1 wherein the wood-based flakes each individually comprise a two-dimensional surface area of no greater than about 322 square mm.

66. The blended mulch product of claim 1 wherein the wood-based flakes each individually comprise a two-dimensional surface area of about 2.5 square mm to about 322 square mm.

67. The blended mulch product of claim 64 wherein about 40% to about 90% of the wood-based flakes each individually comprise the two-dimensional surface area.

68. The blended mulch product of claim 67 wherein about 60% to about 70% of the wood-based flakes each individually comprise the two-dimensional surface area.

69. The blended mulch product of claim 1 wherein about 40% to about 75% of the wood-based flakes each individually comprise a dimension in the range of about 0.125″ to about 0.725″ and a thickness of at least about 0.004″.

70. The blended mulch product of claim 1 wherein the blended mulch product comprises a loading capacity of greater than about 1250 to about 1300 pounds per 3000 gallons of water.

71. The blended mulch product of claim 1 wherein the blended mulch product comprises a loading capacity of at least about 1600 pounds per 3000 gallons of water.

72. The blended mulch product of claim 1 wherein the blended mulch product comprises a loading capacity of about 1750 pounds per 3000 gallons of water.

73. The blended mulch product of claim 1 wherein the blended mulch product comprises a loading capacity of greater than about 1750 pounds per 3000 gallons of water.

74. The blended mulch product of claim 1 wherein the blended mulch product is capable of forming a mulch matrix having good coverage.

75. A method of using the blended mulch product of claim 1 comprising mixing said blended mulch product with water to form a slurry and spraying the slurry on to a surface to be treated with said blend.

76. The method of claim 75 wherein the surface is soil that is at risk for erosion or is eroded.

77. The method of claim 75 wherein the spraying forms a mulch matrix having good coverage.

78. A method of making a blended mulch product suitable for mixing with water for spray application to a surface, the method comprising mixing a plurality of ligno-cellulosic fibers with a plurality of wood-based flakes to make a substantially homogeneous blend, wherein the blended mulch product has a high loading capacity.

79. The method of claim 78 wherein the ligno-cellulosic fibers and the wood-based flakes are mechanically blended.

80. A blended mulch product suitable for mixing with water for spray application to a surface, the blended mulch product comprising:
a) EcoFibre™; and
b) dry, hogged sawtrim from the hardboard process that have been screened using a 0.5 inch wire mesh,
in a substantially homogeneous blend, wherein the blended mulch product has a high loading capacity.
